(19) United States
(12) Patent Application Publication
(10) Pub. No.: US 2026/0295832 A1
(43) Pub. Date: Oct. 1, 2026

(54) SYSTEM FOR MANAGING A VEHICLE SERVICE STATION

(71) Applicant: Rocsys B.V., Rijswijk (NL)

(72) Inventors: Johannes Oosten van der Weijde, Delft (NL); Crijn Bouman, Rijswijk (NL)

(21) Appl. No.: 19/630,220

(22) Filed: Mar. 26, 2026

(30) Foreign Application Priority Data
Mar. 28, 2025 (NL) 2040086
Jul. 9, 2025 (NL) 2040757

(51) Int. Cl. B25J 9/16; G06Q 10/20

(52) U.S. Cl. CPC B25J 9/1661; B25J 9/1679; G06Q 10/20

(57) ABSTRACT

The present invention relates to systems for controlling service stations, and more specifically to a system for managing and controlling the operation of a manipulator used for performing automated tasks on vehicles in a service station, such as a charging, cleaning, maintenance or diagnostic task.

### CROSS-REFERENCE TO RELATED APPLICATION

The present application claims priority from pending Netherlands Patent Application No. 2040086, filed Mar. 28, 2025, and Netherlands Patent Application No. 2040757, filed Jul. 9, 2025, which are incorporated herein by reference.

### TECHNICAL FIELD

The invention relates to the field of service stations for vehicles equipped with robotic systems for task automation.

### BACKGROUND

In modern service stations, there is a growing demand for automating vehicle servicing tasks to improve efficiency, reduce labor costs, and minimize human error.

Service stations may be equipped with robotic systems, also referred to as manipulators, which are capable of performing various tasks on vehicles, such as triage, charging, maintenance, diagnostics, and cleaning. Such robotic systems often work in conjunction with other resources or sub, systems, including parking bays or parking zones, service tools, and backend databases for compatibility and availability information.

However, the effective management of such service stations poses several technical challenges. One of the primary challenges is the assignment and coordination of multiple operational tasks that must be performed on different vehicles, often simultaneously, using a limited set of manipulators and service components. These tasks can vary in complexity, duration, and physical requirements.

The present disclosure addresses the challenges described herein.

### SUMMARY

A first embodiment of the present disclosure relates to a system in accordance with claim 1.

The present disclosure provides a system for controlling a service station provided with resources comprising a manipulator, one or more service components for performing an operational task, and one or more service zones where services are performed on a vehicle, the system comprising one or more processors coupled with a memory, the one or more processors configured to: obtain a service request comprising one or more services to be performed on the vehicle selected from a charging service, a cleaning service, a maintenance service, and a diagnostic service; retrieve, in response to the service request, operational data related to the service station resources; generate, based on the service request and the operational data, an execution plan of operational tasks for fulfilling the service request; and control the manipulator to manipulate the one or more service components for executing the operational tasks in accordance with the execution plan; wherein the execution plan is automatically generated such that a service parameter is realized.

By generating execution plans that are aligned with one or more service parameters, such as minimizing total service time, the system can improve overall operational efficiency of the service station and increase the number of vehicles that can be serviced within a given timeframe.

Additional specific embodiments are described in the dependent claims.

A second embodiment relates to a method for controlling a service station provided with resources including a manipulator, one or more service components for performing an operational task, and one or more service zones where services are performed on a vehicle, the method comprising, by a controller in communication with the service station resources: i) obtain a service request comprising one or more services to be performed on the vehicle selected from a triage, a charging service, a cleaning service, a maintenance service, and a diagnostic service; ii) retrieve, in response to the service request, operational data related to the service station resources; iii) generate, based on the service request and the operational data, an execution plan of operational tasks for fulfilling the service request; and iv) control the manipulator to manipulate the one or more service components for executing the operational tasks in accordance with the execution plan; wherein the execution plan is automatically generated such that a service parameter is realized.

### BRIEF DESCRIPTION OF THE DRAWINGS

FIG. 1A is a block diagram of a system according to one aspect of the present disclosure.

FIG. 1B is a block diagram of a system according to one aspect of the present disclosure.

FIG. 2 is a flowchart of a method according to an embodiment of the present disclosure

FIG. 3 shows a simplified structural block diagram of a computing environment.

### DETAILED DESCRIPTION

The present invention is described with reference to flowcharts and block diagrams illustrating the method, system, and apparatus according to the several embodiments. Each block or combination of blocks may be implemented using computer program instructions or corresponding hardware. These instructions can be executed by a general, purpose or special, purpose computer, embedded processor, or other programmable device to perform the specified functions or operations.

The computer program instructions may be stored in a computer, readable memory to instruct a computer or programmable device to function in a particular way, thereby allowing the implementation of the specified functions or operations.

These instructions may also be loaded onto a computer or programmable device to execute a series of steps, resulting in computer, implemented processing. The order of functions or operations in the flowcharts may vary, with some blocks being performed simultaneously or in reverse order, depending on the specific process.

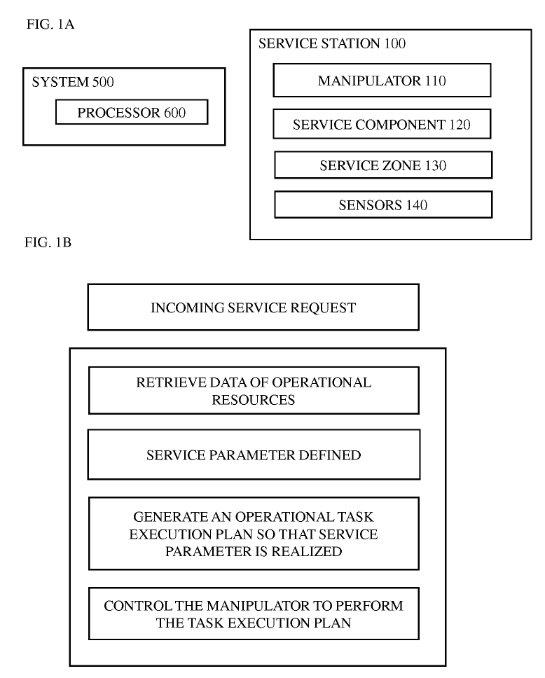

In reference to FIG. 1A, a system 500 for controlling a service station 100 is depicted. Service station 100 is provided with operational resources including a manipulator 110, a service component 120 and a service zone 130. Manipulator 110 is equipped with, or in communication with various sensors 140 to support the execution of the operational tasks. These sensors may include, but are not limited to, computer vision systems for object recognition and spatial localization, force sensors, proximity sensors, and inertial measurement units (IMUs). Preferably, a camera sensor is coupled to the manipulator, which facilitates the system to determine the position of a charging connector or another service component, as well as to identify the charging inlet on a vehicle or a stand holding cleaning service components. With this data, the manipulator can determine a movement path and position the service component relative to the vehicle to perform the operational task, including aligning and engaging the service component with a corresponding interface on the vehicle or within the service zone

In reference to FIG. 1B, a flow diagram is shown of a process of the system 500. Upon receiving an incoming service request, the system retrieves operational resource data, such as the current availability and status of manipulators, service components, and service zones. A service parameter may be defined together with the service request, which may be a parameter selected by the operator, derived from vehicle, specific requirements, or determined by system configuration. Based on the service request and operational data, the system then generates an execution plan including one or more operational tasks that aims to fulfill the service request along with the defined service parameter. Finally, the system controls the manipulator to perform the defined operational tasks in accordance with the generated plan, thereby executing the requested service.

In an example, a service station is adapted to execute charging and cleaning service requests for a vehicle using multiple manipulators. One manipulator is configured to perform charging services, while another is adapted for executing cleaning operations. The service station is equipped with designated service zones, which may include separate zones for charging and cleaning, or shared zones where both types of services can be carried out by the respective manipulators. An incoming service request is received, including a triage for assessing the level of cleaning required as well as a charging request. The service parameter requires prioritizing this vehicle over other existing tasks. Based on the service request, the triage result, and operational data related to the current availability and status of the manipulators, service components, and service zones, the system generates an execution plan that reallocates resources to prioritize servicing of the vehicle. The triage indicates that only a limited cleaning operation is required, including interior debris removal or wiping of selected surfaces, rather than a full cleaning routine. In response, the execution plan may schedule the limited cleaning operation to be performed first by the cleaning manipulator in an available cleaning zone, while reserving or preparing a charging manipulator and compatible charging component for a subsequent charging task. Alternatively, when a shared service zone is available and the operational data indicate that spatial overlap can be avoided, the execution plan may schedule at least part of the cleaning and charging related operations in overlapping time periods so as to reduce total service duration. Existing lower-priority tasks may be delayed, interrupted at a safe pause point, or reassigned to other resources in order to realize the service parameter. In this way, the system uses the triage-derived cleaning level as an input for planning, such that the vehicle receives a level of cleaning sufficient for the request while achieving prioritized readiness for operation.

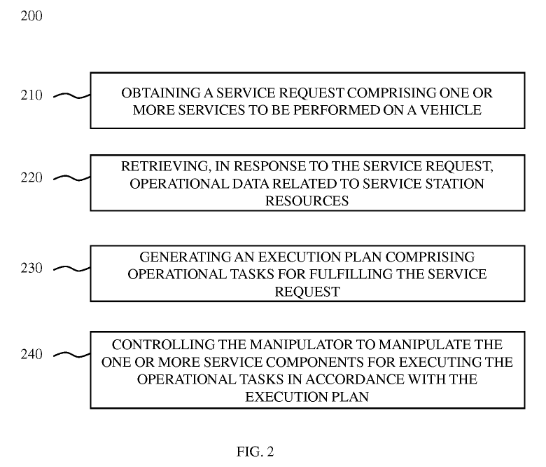

FIG. 2 depicts a method 200 for controlling a service station.

Step 210 comprises obtaining a service request comprising one or more services to be performed on a vehicle, the one or more services selected from a triage, a charging service, a cleaning service, a maintenance service, and a diagnostic service.

Step 220 comprises retrieving, in response to the service request, operational data related to service station resources, the resources comprising a manipulator, one or more service components for performing an operational task, and one or more service zones where services are performed on the vehicle.

Step 230 comprises generating, based on the service request and the operational data, an execution plan comprising operational tasks for fulfilling the service request, wherein the execution plan is automatically generated such that a service parameter is realized.

Step 240 comprises controlling the manipulator to manipulate the one or more service components for executing the operational tasks in accordance with the execution plan.

In more detail, step 210 of obtaining a service request, such as a charging request, may include a service parameter associated with that request. For example, the service request may specify that all incoming vehicles are to be charged to 80% of their battery capacity, and further indicate that vehicles should be inspected and cleaned if certain predefined conditions are met, such as the detection of visible exterior dirt, interior debris, or identification as a recent rental return through a triage. The service request may have an associated service parameter such as minimizing total service duration, prioritizing vehicles that require fewer tasks, or aligning charging operations with off, peak energy pricing. The service request may be received via a user interface, a backend system, or automatically from the vehicle itself.

In more detail, step 220 includes retrieving operational data related to the service station resources, based on the information obtained in step 210. For example, if the service request specifies a charging service for a vehicle of a particular type, the system retrieves data indicating the availability and status of charging connectors, the current task queue of each manipulator, the occupancy status of service zones, and compatibility parameters between available service components and the vehicle’s connector type.

The operational data may include real-time and historical operational task execution data, including task execution times, energy consumption, resource allocation efficiency, and delays. The system may use such data to identify patterns and inefficiencies in previous task execution plans and to assign operational tasks to available service resources based on current availability.

Operational resource data may further include the current availability and status of manipulators, service components, and service zones. For example, this data may comprise: (1) occupancy information indicating whether a service zone is in use, blocked, or available; (2) task queues associated with each manipulator or service zone, including estimated completion times and scheduled task transitions; (3) functional status of service components, such as whether a charging connector, cleaning tool, or diagnostic interface is operational, requires maintenance, or is currently engaged; (4) compatibility profiles of manipulators and service components with respect to specific vehicle models and service types, defined by factors such as interface type, range of motion, or load capacity; (5) performance metrics including average task duration, error rates, manipulator idle time, frequency of tool changes, or downtime statistics; and (6) environmental or contextual data that may affect task execution, including lighting conditions, temperature, energy availability, spatial constraints, or the presence of obstacles.

The operational data may further include real-time sensor feedback and predefined boundary conditions such as spatial clearance or energy availability. Such boundary conditions may include spatial, service-function, and environmental conditions, for example that the vehicle is parked in accordance with alignment guidelines to allow manipulator access to service components such as charging inlets or cleaning areas. Other examples include minimum clearance distances around the vehicle for manipulator operation, zone-specific constraints such as restricted entry times, load-bearing capacity of the service zone floor, environmental limitations such as temperature or humidity thresholds for specific services, and predefined power or energy allocation limits.

In more detail, step 230 comprises generating an execution plan with the operational tasks required for fulfilling the service request in consideration of the operational data retrieved in step 220. The system may analyze one or more operational tasks and evaluate the impact of performing each task at a determined service zone with a determined service component on achieving the service parameter. Based on this analysis, the system generates the execution plan, including sequencing and allocation of tasks. For example, if the service request involves charging and cleaning, and operational data indicates that one manipulator is currently occupied and two service zones are available, the system may schedule the cleaning task to start first in a free zone while deferring the charging task until the manipulator becomes available.

### Spatial overlap

The execution plan may be generated in consideration of spatial overlap. For example, if two operational tasks are scheduled to occur in adjacent service zones, and the movement path of the manipulator required for one task intersects with the service area of another task, the controller identifies this spatial overlap and adjusts the task sequence to avoid interference. This may include updating the execution plan by deferring one task until the other is completed, reassigning a task to a non conflicting zone, or modifying any of the manipulator’s path.

Spatial overlap may be determined by assessing whether a movement path or service area of a manipulator assigned to an operational task intersects with the movement path or service area of another operational task, based on real, time or predefined spatial configuration data of the service zones and manipulators. The system may further evaluate a clearance area surrounding the manipulator's movement path, taking into account the operational footprint required for safe task execution. An overlap is determined when this clearance area for one task intersects with that of another task, indicating a potential spatial conflict.

The clearance area may be defined based on one or more of: dimensions of the manipulator and attached service component, required safety margins, movement tolerances, and environmental constraints within the service zone. The determination may be performed using real-time sensor data and/or stored spatial models, and may be continuously updated during execution of the operational tasks to allow adjustment of the execution plan.

### Compatibility

The execution plan may be generated in consideration of compatibility between the manipulator and the service component required to fulfill the one or more operational tasks. For example, the system may determine, based on the operational data, whether the manipulator is compatible with the service component, the vehicle to be serviced, and the service zone in which the task is to be performed. Compatibility may include evaluating whether the manipulator’s range of motion and degrees of freedom are sufficient to position the service component at the required location on the vehicle for task execution within the spatial configuration of the assigned service zone. If the compatibility conditions are not met, the system may select a different manipulator, service component, or service zone as part of generating the execution plan.

For example, a service zone may be configured to perform charging operations for vehicles having charging inlets located at different positions, such as on a side, front, or rear portion of the vehicle. When a vehicle having a front-located charging inlet is to be serviced, the system determines whether the range of motion of the manipulator allows access to the inlet within the spatial constraints of the assigned service zone. This may require that the vehicle is positioned such that a predefined clearance space is available for the manipulator to approach and align the charging connector. During analysis of the operational data, the system verifies vehicle-specific parameters, including inlet location and required positioning, and determines whether the available clearance space satisfies the compatibility conditions. If the clearance space is insufficient, the system may, as part of the execution plan, generate an instruction to reposition the vehicle within the service zone or to an alternative service zone that satisfies the compatibility requirements.

In more detail, step 240 comprises controlling the manipulator to manipulate the one or more service components for executing the operational tasks in accordance with the execution plan. For example, the execution plan may define the specific sequence, timing, and spatial positioning of tasks, and this information directly governs the manipulator’s movement path, speed, and tool selection. The manipulator may be instructed to move to a predefined location within a service zone only after confirming task dependencies, compatibility and clearance constraints, as outlined in the execution plan. If the plan specifies a charging task, the manipulator follows the movement path optimized in the plan to retrieve the designated charging connector, align with the vehicle inlet using positional data, and initiate the connection procedure. Manipulator actions, including pick, up, alignment, operation, and return, are executed in accordance with parameters established by the execution plan, which may include timing buffers, priority assignments, spatial avoidance rules, and compatibility conditions.

Additionally, at any stage of the process, the system is configured to generate and transmit a signal to the vehicle, directing it to a specific service zone at a designated time. For example, once the execution plan allocates a charging or cleaning task to a vehicle, the system may send a notification via the backend or direct vehicle interface, instructing, for example: Vehicle A to reposition from Buffer Zone 1 to Charging Zone 2 by 15:05; Vehicle B to enter Cleaning Zone 3 immediately after Vehicle A departs; and/or Vehicle C to shift to Waiting Area 1 at 16:30 pending availability of a cleaning manipulator. Signals and instructions may be communicated to the vehicle directly, relayed through a site- or fleet operator, or station- or fleet manager, or presented via in‑app notifications. The system is further configured to receive a signal or confirmation from the vehicle indicating that it has repositioned in accordance with the instructions, allowing the system to proceed with, or resume, the scheduled tasks of the execution plan.

The execution plan is automatically generated such that a service parameter is realized. In particular, the system may analyze one or more operational tasks and evaluate the impact of performing such tasks on achieving the service parameter. The system may further evaluate one or more candidate execution plans and select, adapt, or update the execution plan based on the evaluation to achieve the defined service parameter within constraints of the operational resources. Additional service parameters may include, for example: maximizing the number of vehicles made operational within a predetermined timeframe; minimizing total service duration; minimizing idle time of manipulators or service components; prioritizing vehicles based on urgency, service type, or predefined priority classes; reducing the number of tool changes or manipulator movements; optimizing energy consumption, including aligning charging operations with off-peak energy availability or grid service requirements; maximizing throughput of the service station; and/or balancing resource utilization across multiple service zones or service stations. In some embodiments, multiple service parameters may be considered simultaneously, wherein the system applies a weighted or hierarchical optimization to balance objectives when generating or updating the execution plan.

### EXEMPLARY EMBODIMENTS

In a first illustrative example, the service station receives a service request to charge five vehicles, accompanied by a service parameter indicating that all vehicles, including those currently in a queue or under a service, must be made operational and returned to service as quickly as possible and that exterior cleaning may be suspended. At the time of receiving this request, the service station is already engaged in ongoing tasks involving the charging and cleaning of two other vehicles. In response, and based on the defined service parameter, prioritizing rapid vehicle readiness, the system generates an operational task execution plan that reallocates available resources, including manipulators and service components, to prioritize charging activities.

The execution plan includes at least one of the following tasks: suspension or modification of non-critical cleaning activities to prioritize urgent charging operations. In particular, in view of the service parameter indicating that exterior cleaning may be skipped, the system selectively omits or terminates exterior cleaning tasks while optionally allowing essential or already initiated interior cleaning tasks to reach a defined safe pause point. Specifically, the system issues instructions to the cleaning manipulators to: (1) terminate or skip exterior cleaning routines and, where applicable, conclude ongoing cleaning operations at a defined safe pause point; (2) deactivate active cleaning components such as vacuum nozzles, brushes, or disinfectant sprayers; (3) retract and secure all movable parts, including robotic arms and cleaning heads; (4) navigate to a predefined standby location outside the operational range of the charging manipulators; and (5) enter a low-power standby mode to minimize energy consumption. Furthermore, the system instructs the charging manipulators to: (6) move into position adjacent to the next vehicle in the charging queue; (7) verify connector type compatibility using vehicle-specific parameters; (8) retrieve the appropriate charging connector from its docking station; and (9) align and initiate the charging process following successful positioning and safety checks. In shared service zones, the execution plan further includes: (10) repositioning any cleaning service components to safe, non-obstructive areas using predefined clearance paths

In a second illustrative example, the service station receives a service request to charge all incoming vehicles, with a service parameter indicating that charging operations should be conducted during night hours and cleaning operations should be performed during daylight hours. Based on the service request and the service parameter, the system generates an execution plan comprising temporal allocation of operational tasks across defined time windows. In particular, the execution plan schedules cleaning tasks to be executed during daylight hours upon vehicle arrival, including assigning available cleaning manipulators and service zones to perform the required cleaning operations, while deferring charging tasks to a designated nighttime charging window. The execution plan may further include instructions to a vehicle management component to direct vehicles, after completion of cleaning, to buffer zones or staging areas in preparation for subsequent charging. During the night hours, the execution plan schedules charging tasks by allocating available charging manipulators and service components, and instructs vehicles to move from the buffer zones to charging zones in accordance with the planned sequence. The system may further optimize the execution plan by aligning charging activities with energy availability, grid conditions, or predefined energy pricing profiles, while spatial and resource constraints are satisfied.

In a third illustrative example, the service station is provided with a service zone for charging, a separate service zone for cleaning, and one or more buffer parking spots. The service station receives service requests for vehicles requiring both charging and cleaning, accompanied by a service parameter indicating that all vehicles must be made operational as quickly as possible. Upon arrival, the system performs a triage to determine the level of cleaning required for each vehicle. Based on the triage results, the system generates an execution plan that prioritizes vehicles requiring limited or no cleaning and/or shorter charging times, such that these vehicles can be returned to operation more quickly. Vehicles requiring more extensive cleaning are scheduled at a later stage and may be temporarily directed to buffer parking. In this way, the system differentiates service levels and orders tasks to maximize the number of vehicles made operational within the shortest time.

In an extension of this example, the triage determines the expected duration and type of cleaning tasks for each vehicle. Based on this information, the system schedules and, if necessary, re-schedules cleaning and charging tasks, such that vehicles requiring extensive cleaning are deferred, while vehicles requiring minimal cleaning and charging are prioritized in the execution plan.

In a fourth illustrative example, the system manages service operations across two or more distinct service stations located in different areas (e.g., several depots within the same city), wherein vehicles continuously arrive at the service stations with one or more assigned service requests. Each incoming service request may include one or more requested services, such as charging and cleaning, and an associated service parameter. As vehicles arrive, the system evaluates the current operational load, including active tasks, queued vehicles, and available resources at each service station. When the inflow of vehicles exceeds the processing capacity of a particular service station, based on the current level of service requests, associated service parameters and resources operational data, the system generates an execution plan that includes routing instructions to distribute the workload across multiple service stations.

For example, when the queue for charging at a first service station indicates that no additional charging tasks can be initiated within a predefined time window, such as the next 90 minutes, the system determines that the capacity of the first service station is exceeded with respect to the service parameter. In response, the system identifies one or more alternative service stations having available capacity and generates routing instructions to redirect one or more incoming or queued vehicles to the alternative service station. The execution plan may further include instructions to a vehicle management component to guide the vehicle to the selected service station, optionally via an intermediate buffer location. Additionally, the system may reallocate or reschedule operational tasks across the service stations to balance workload and ensure that the service parameter, such as minimizing total service time or maximizing vehicle availability, is achieved

In a fifth illustrative example, the system controls a service station configured to perform charging services on vehicles located in one or more service zones within said service station. The system obtains a service request comprising a charging service to be performed on six vehicles, including three vehicles of a first type (type A) and three vehicles of a second type (type B). Operational data retrieved, or previously stored by the system include target parking position and orientation of the vehicle types within the service zones, positions of the charging connectors, spatial configuration of the service zones, and charging inlet positions associated with each vehicle type.

Based on the service request and the operational data, the processors analyse compatibility of vehicle type with executing the service request by the manipulator in a service zone using service components, and generate an execution plan comprising operational tasks for fulfilling the charging service.

Operational data comprises previously stored data associated to the service zones and its compatibility with vehicles and service requests. These predefined compatible service zones for vehicle types with a particular request may largely, or completely overlap with predefined compatible service zones for different vehicle types with a particular request

The operational tasks include instructions for the manipulator to move to a connector stand, pick up a charging connector, move the connector to a vehicle located in a service zone, and plug-in the connector into the vehicle charging inlet. The execution plan further includes the sequence, a designated service zone, and a time window for executing each of the operational tasks.

In this example, the operational data indicate that vehicles of type B have a charging inlet located at a front portion of the vehicle, whereas vehicles of type A have a charging inlet located at a side portion of the vehicle. Due to the differing inlet positions, there is a spatial variation in the required reach and approach angle of the manipulator. To accommodate this, the execution plan includes instructions to a vehicle positioning system or service station coordinator to position vehicles within the service zone such that the respective charging inlets are accessible and within the effective range and clearance space of the manipulator. In particular, vehicles of type B are positioned such that the front portion of the vehicle is oriented toward the manipulator, while vehicles of type A are positioned such that the side portion containing the charging inlet is accessible. This positioning reduces the required reach and complexity of manipulator movement.

In a further illustrative example, the service station comprises a first manipulator configured to perform a charging task in a first service zone and a second manipulator configured to perform a cleaning task in a second service zone adjacent to the first service zone. The system receives a first service request to charge a first vehicle and a second service request to clean a second vehicle. Based on the service requests and corresponding operational data, the system initially generates an execution plan in which the first manipulator is scheduled to move a charging connector from a connector stand to the charging inlet of the first vehicle during a first time window, while the second manipulator is scheduled to perform a cleaning operation on the second vehicle during a second time window.

During analysis of the operational tasks, the system determines whether execution of the first operational task conflicts with execution of the second operational task. In particular, the system determines that a movement path associated with the first manipulator for performing the charging task intersects with a movement path associated with the second manipulator for performing the cleaning task. The system further determines that the spatial overlap occurs during overlapping time windows of the first and second operational tasks, thereby identifying a conflict between the operational tasks.

In response to determining the conflict, the system modifies the execution plan. In one embodiment, the system reschedules at least one of the first or second operational task such that the movement paths no longer overlap in time. In another embodiment, the system generates a plurality of candidate execution plans that resolve the conflict, including: (i) delaying the charging task until completion of the cleaning task; (ii) delaying the cleaning task until completion of the charging task; and (iii) reassigning one of the operational tasks to a different service zone. The system then evaluates the candidate execution plans with respect to the service parameter, for example minimizing total service duration or maximizing vehicle availability, and selects the candidate execution plan that best satisfies the service parameter.

Some further aspects and examples of the present disclosure are outlined below.

As used herein, a manipulator is a controllable actuated mechanism configured to manipulate one or more service components to perform operational tasks on a vehicle. The manipulator may comprise a robotic arm or other programmable device, and may be purpose-built for a specific task, general-purpose with interchangeable service components, or a humanoid or semi-humanoid robotic system.

As used herein, a service zone is an area within a service station designated for performing one or more operational tasks on a vehicle. A service zone may be configured for a specific service activity, such as charging, cleaning, maintenance, diagnostics, or triage, or may be configured as a shared zone for multiple service activities. A service zone may be associated with one or more manipulators, service components, positioning requirements, clearance constraints, and occupancy conditions used by the system in generating and executing the execution plan.

As used herein, a service component refers to a physical or functional element configured to be manipulated by the manipulator for performing an operational task on a vehicle. Service components may include, for example, charging connectors, cleaning tools, diagnostic interfaces, and maintenance tools. A service component may be removably coupled to the manipulator or accessible from a predefined location, such as a docking station, and may be activated, deactivated, positioned, or exchanged by the manipulator during execution of the operational tasks.

The service request defines what services are to be performed on a vehicle, while the service parameter defines how such services are to be executed by specifying one or more objectives, constraints, or preferences. The service parameter serves as a function guiding the system in performing the requested services using the available robotic resources, including manipulators, service components, and service zones. The execution plan is generated based on the service request and operational data, and is selected or optimized in accordance with the service parameter.

The relationship between the service request and the service parameter may be expressed such that the execution plan is generated to fulfill the requested services while being optimized in accordance with one or more objectives and/or constrained by one or more conditions defined by the service parameter.

Examples of service parameters include minimizing total service time; maximizing the number of vehicles made operational within a predetermined timeframe or as quickly as possible; maximizing throughput of the service station; reducing non-functional operational tasks such as idle movement, unnecessary repositioning, or excessive tool changes; improving utilization of manipulators, service components, and service zones; prioritizing vehicles based on urgency, service type, or the number of required tasks; and optimizing energy use by aligning charging operations with grid demand, such as performing charging during off-peak or night hours and scheduling other services, such as cleaning, during daytime hours.

Examples of service parameters may further include differentiated service levels, for example prioritizing vehicles requiring limited cleaning or shorter charging durations over vehicles requiring more extensive operations, or allowing certain service actions, such as exterior cleaning, to be skipped to improve vehicle availability. Service parameters may also impose constraints on service delivery, such as specifying a required minimum, preferred, or maximum state of charge, limiting cleaning duration or scope, defining time windows for task execution, or allowing load balancing across multiple service stations, including rerouting vehicles when local capacity is exceeded.

More particularly, the service parameter may include one or more of the following: (i) executing as many service requests as possible within a defined time frame, optionally preserving capacity for premium or emergency requests; (ii) maximizing the number of vehicles made operational within a target time or by a specific deadline; (iii) prioritizing vehicles that require fewer tasks (e.g., charging, only vehicles over those needing both charging and cleaning); (iv) diverting long, dwelling vehicles to buffer or lower, demand zones to free up critical resources; (v) performing triage, driven task planning to reduce uncertainty in execution time; (vi) maximizing grid, service utilization by charging or discharging vehicles according to real, time grid requirements; (vii) respecting fairness, based scheduling such as first, in, first, out or priority queues; or (vii) optimizing service outcomes for specific vehicle categories, such as fleets or rental units.

Service parameters may be selected by the service station operator, provided by the vehicle or its backend system, configured based on operational policies, inferred from historical usage patterns or performance data, or determined through a combination of these sources Additionally, the service parameter may include an optimization target.

Preferably, the system is configured to perform a triage on a vehicle to determine an extent of one or more services to be performed. The triage may include analyzing sensor data, vehicle-provided data, or historical information to assess the required level of cleaning, charging, maintenance, or diagnostic operations. Based on the triage, the system may classify the vehicle into a service category or determine a scope of required operational tasks, which is used as input for generating the execution plan.

A cleaning service request may also include specify particular exterior/interior areas to be addressed, such as windshields, doors, or wheel wells; desired cleaning programs or finishes (e.g., standard wash, deep clean, spot treatment, waxing, polishing); and targeted interior zones (e.g., seats, dashboard, carpets, windows). The service request may further define cleaning methods such as wiping, vacuuming, object removal, and disinfection, and may reference program types (e.g., quick clean, full detailing, pet hair removal).

A charging service request may include one or more of the following: target state, of, charge (e.g., 80%), minimum or preferred energy delivery amounts, preferred charging speed (e.g., slow, fast, ultra, fast), and battery longevity guidelines (e.g., avoid exceeding 90% charge to extend battery health). It may also specify the charging protocol to be used (e.g., AC, DC fast charging, wireless, battery swap), inlet location details, and whether the vehicle can provide or consume grid services. Charging service requests may also include tiered charging parameters, e.g., a minimum acceptable level, a preferred level, and a maximum cap.

A maintenance service request may include predefined diagnostic checks such as tire pressure inspection, fluid level verification, brake wear analysis, or software, based fault detection. It may also request scheduled service actions, including oil changes, filter replacements, and firmware or software updates. Immediate or condition, based maintenance may include recalibration of sensors, minor mechanical adjustments, or component inspection triggered by earlier diagnostics or operator input

A diagnostic service request may include actions such as fault code retrieval and reporting, sensor and system calibration tests, predictive maintenance evaluations based on historical and contextual data, as well as emission testing and regulatory compliance checks. The request may also be linked to vehicle, specific diagnostic protocols or backend databases to guide appropriate task selection.

The service request may include, or be associated with, detailed vehicle, related information including a vehicle identification parameter (e.g., vehicle ID or license plate), vehicle type and model, arrival and/or departure time, authentication credentials, security requirements, and supported service interfaces. Additional data may include inlet specifications (e.g., connector type, location, clearance), charging capabilities, and supported payment or authorization methods such as Plug, and, Charge, fleet operator credentials, or direct user input. The service request may further include one or more conditions associated with the execution of service tasks, such as mandatory preconditions (e.g., minimum clearance), environmental constraints (e.g., temperature range), or inter, service dependencies (e.g., charging only after cleaning is completed).

In general, the system is designed to fulfill one or more service requests by utilizing the full set of available resources within its operational scope. This includes, but is not limited to, service components, manipulators, and multiple service zones within the service station. In some cases, the system can control resources allocated within adjacent or remote service stations.

As used herein, an execution plan is a sequence of operational tasks generated by the system based on a received service request, a service parameter and current operational conditions. The operational tasks may include one or more charging operational tasks, cleaning operational tasks, maintenance operational tasks, and diagnostic operational tasks.

The execution plan may define, for each task, the associated manipulator movements, the service components to be utilized, the time or order of execution, and the designated service zone. This plan can be generated or adjusted to align with a defined service parameter, and may further include instructions to a vehicle or a vehicle management system to park or reposition the vehicle to allow execution of the operational tasks.

An execution plan may comprise combined operational tasks involving coordinated actions to be performed by one or more manipulators for executing multiple service activities, such as charging, cleaning, maintenance, and diagnostics. The operational tasks may include one or more instructions for the manipulator to: (i) move to a designated service zone; (ii) pick up, release, or exchange a service component; (iii) activate or deactivate a service component; and (iv) move and/or position the service component relative to the vehicle for execution of the operational task.

By performing such operational tasks, the manipulator may execute actions including: positioning at a vehicle location; performing cleaning operations such as wiping, vacuuming, or object removal; retrieving and connecting a charging connector and initiating a charging process; performing diagnostic routines such as scanning or calibration; and performing maintenance actions such as inspection or component handling. The manipulator may further perform tool transitions, including exchanging service components as required for different tasks.

The execution plan may further define sequencing and coordination parameters, including time windows for task execution, inter-task dependencies, spatial separation constraints to avoid conflicts, priority rules for task ordering, and buffer periods for transitions between tasks.

For example, the execution plan may be generated by applying optimization criteria such as minimizing the number of tool changes for manipulators, particularly during cleaning tasks, to reduce transition overhead, or prioritizing task sequences that limit manipulator path interference and reduce travel distance, thereby improving overall task efficiency and throughput.

A machine learning model may be used to generate the task execution plan by: evaluating multiple candidate execution plans through a simulation environment that models the service resources, and constraints of the service station; assigning a reward score to each candidate execution plan based on its alignment with the operator, selected service parameter; iteratively refining the execution plan by applying policy optimization techniques to maximize the expected reward associated with the service parameter; and selecting the refined task execution plan with the highest expected performance score.

The system may evaluate multiple potential task execution plans and selects the plan that is most likely to achieve the chosen service parameter within predefined constraints.

The system 500 may comprise a vehicle management component which coordinates the moving, and/or parking position and/or orientation of the vehicles so that the operational tasks can be executed in a way that the service parameter chosen by the operator is realized.

The system 500 may provide a response to a service request, comprising a denial or acceptance of the service request. The system according to any of the preceding claims, wherein the system provides information to a facility, management system on services rendered to a vehicle.

The system 500 may further comprise a user interface operatively coupled to the processing unit, the user interface configured to receive input from the operator and present information to the operator.

The system 500 may analyze the utilization of each of the resources, and prioritizes optimizing the use of the resources that most impact the service parameter.

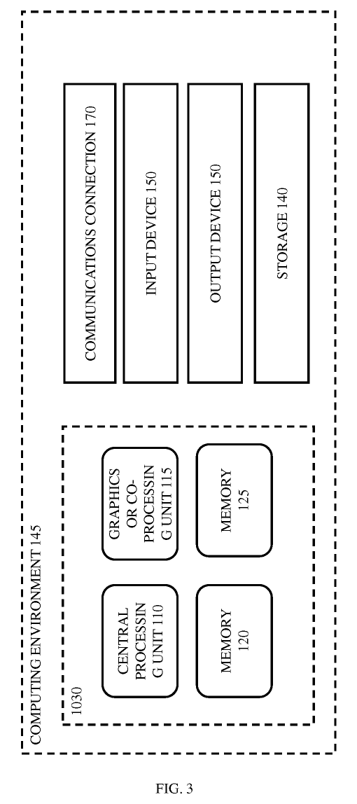

FIG. 3 depicts a generalized example of a suitable computing environment 145 in which the described innovations may be implemented. The computing environment 145 is not intended to suggest any limitation as to scope of use or functionality, as the innovations may be implemented in diverse general, purpose or special, purpose computing systems. For example, the computing environment 145 can be any of a variety of computing devices (e.g., desktop computer, laptop computer, server computer, tablet computer, etc.)

With reference to FIG. 3, the computing environment 145 includes one or more processing units 110, 115 and memory 120, 125. In FIG. 3, this basic configuration 1030 is included within a dashed line. The processing units 110, 115 execute computer, executable instructions. A processing unit can be a general, purpose central processing unit (CPU), processor in an application, specific integrated circuit (ASIC) or any other type of processor. In a multi, processing system, multiple processing units execute computer, executable instructions to increase processing power. For example, FIG. 3 shows a central processing unit 110 as well as a graphics processing unit or co, processing unit 115. The tangible memory 120, 125 may be volatile memory (e.g., registers, cache, RAM), non, volatile memory (e.g., ROM, EEPROM, flash memory, etc.), or some combination of the two, accessible by the processing unit(s). The memory 120, 125 stores software implementing one or more innovations described herein, in the form of computer, executable instructions suitable for execution by the processing unit(s).

A computing system may have additional optional features. For example, the computing environment 145 includes storage 140, one or more input devices 150, one or more output devices 150, and one or more communication connections 170. An interconnection mechanism (not shown) such as a bus, controller, or network interconnects the components of the computing environment 145. Typically, operating system software (not shown) provides an operating environment for other software executing in the computing environment 145, and coordinates activities of the components of the computing environment 145.

The tangible storage 140 may be removable or non, removable, and includes magnetic disks, magnetic tapes or cassettes, CD, ROMs, DVDs, or any other medium which can be used to store information in a non, transitory way and which can be accessed within the computing environment 145. The storage 140 stores instructions for the software implementing one or more innovations described herein.

As used in the present disclosure, the term "position" refers to a spatial position and/or orientation in any one of a three, four, five, or six, dimensional space of an object. Additionally, or alternatively, the pose may involve dimensions of information representing the object's position and/or orientation relative to the camera or other detection device.

As used herein, "manipulating" refers not only to the act of moving the charging, port cover to achieve a desired position or orientation but also to the physical interaction between the cover manipulator and a part of the vehicle. Such interaction may serve to obtain information about the pose of the charging, port cover or other related features.

For clarity, only selected aspects of software implementations are described, and well, known details are omitted. The disclosed technology is not limited to specific programming languages or hardware.

Terms like “configured to” or “able to” encompass components in active, inactive, or standby states, unless otherwise specified.

The terms “comprising,” “including,” and “having” are used inclusively and do not exclude additional elements. “Or” is inclusive, meaning one, some, or all items in a list. The articles “a,” “an,” and “the” mean “one or more” unless specified otherwise. “At least one of” or “and/or” refers to any combination of listed items.

The detailed description is illustrative, and variations that do not depart from the essence of the claimed invention are within its scope.

1. A system for controlling a service station provided with resources comprising a manipulator, one or more service components for performing an operational task, and one or more service zones where services are performed on a vehicle, the system comprising one or more processors coupled with a memory, the one or more processors configured to:
− obtain a service request comprising one or more services to be performed on the vehicle selected from a charging service, a cleaning service, a maintenance service, and a diagnostic service;
− retrieve, in response to the service request, operational data related to the service station resources;
− generate, based on the service request and the operational data, an execution plan of operational tasks for fulfilling the service request;
− control the manipulator to manipulate the one or more service components for executing the operational tasks in accordance with the execution plan; and
− wherein the execution plan is automatically generated such that a service parameter is realized.

2. The system according to claim 1, wherein the service parameter comprises completing a target number of service requests within a predetermined timeframe, and preferably maximizing a number of service requests performed within the predetermined timeframe.

3. The system according to claim 1, wherein the service parameter comprises maximizing the number of vehicles available for operation within a predetermined timeframe or at a predetermined time.

4. The system according to claim 1, wherein the operational tasks comprise one or more of: an instruction for the manipulator to move to a service zone; and an instruction for the manipulator to pick up, release, turn on, turn off, position, or move a service component.

5. The system according to claim 1, wherein the system is configured to analyze one or more operational tasks required to fulfill the service request, evaluate the impact of performing each task at a determined service zone with a determined service component on achieving the service parameter, and, based on the analysis, generate the execution plan.

6. The system according to claim 5, wherein the analysis comprises determining whether a position of the vehicle within a service zone satisfies a predetermined clearance area required for execution of the operational task by the manipulator, the predetermined clearance area being associated with the vehicle and a movement path of the manipulator.

7. The system according to claim 6, wherein the clearance area is determined based on a position of a charging inlet of the vehicle.

8. The system in accordance with claim 6, wherein in response to determining that the position of the vehicle does not satisfy the predetermined clearance area, generating an instruction to be received by the vehicle or a vehicle management system to reposition the vehicle such that the predetermined clearance area is satisfied.

9. The system according to claim 5, wherein the analysis comprises determining whether execution of a first operational task conflicts with a second operational task, and in response to determining a conflict, modify the execution plan.

10. The system according to claim 9, wherein the conflict is based on spatial overlap.

11. The system according to claim 10, wherein determining whether the first operational task conflicts with the second operational task comprises determining whether a movement path associated with a manipulator for the first operational task intersects with a movement path associated with a manipulator for the second operational task.

12. The system according to claim 9, wherein determining whether the first operational task conflicts with the second operational task further comprises determining whether the spatial overlap occurs within overlapping time windows of the first and second operational tasks.

13. The system according to claim 9, wherein modifying the execution plan comprises rescheduling at least one of the first or second operational task.

14. The system according to claim 9, wherein modifying the execution plan comprises: generating a plurality of candidate execution plans that resolve the conflict; and selecting one of the candidate execution plans based on an evaluation of each candidate execution plan with respect to the service parameter.

15. The system according to claim 1, wherein the one or more processors are configured to determine a performance metric associated with execution of one or more operational tasks based on the operational data, and modify the execution plan based on the performance metric the performance metric comprises at least one of: predicted execution time, queue length, resource utilization, or energy consumption.

16. The system according to claim 1, wherein the one or more processors are configured to perform a triage to determine a level of service required for the vehicle, and generate the execution plan by prioritizing operational tasks associated with vehicles requiring a lower level of service.

17. The system according to claim 1, wherein the execution plan comprises: at least one of i) a sequence of operational tasks to be performed by the manipulator; ii) a description and/or allocation of one or more service components associated to each operational task; iii) a time in which each operational task is scheduled to be performed; and iv) a service zone where each operational task is scheduled to be performed.
